(19) United States
(12) Patent Application Publication
(10) Pub. No.: US 2002/0184306 A1
(43) Pub. Date: Dec. 5, 2002

(54) System and method for preparing imaging data for printing to a requested web service

(76) Inventors: Shell S. Simpson, Boise, ID (US); Ward S. Foster, Boise, ID (US); Kris R. Livingston, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/874,410

(22) Filed: Jun. 4, 2001

(51) Int. Cl. G06F 15/16

(52) U.S. Cl. 709/203; 709/246

(57) ABSTRACT

A system and method for preparing imaging data for printing to a requested web service from an application loaded on a user's computing device. The present invention includes an imaging client computer having a web browser for printing from the application to the requested web service, a personal imaging repository associated with a particular user for storing imaging data that is to be accessed by the requested web service, and a capture driver for preparing the imaging data for transfer to the personal imaging repository. The personal imaging repository is an exchange infrastructure between the imaging data and available web services on the Internet.

The present invention generally relates to an improved system and method for preparing imaging data for printing to a requested web service. More specifically, it relates to an improved system and method for preparing imaging data for printing from an application to a requested web service from a computer with a web browser and a capture driver having a printer driver and a port monitor, wherein the computer is linked to a personal imaging repository having an imaging data store for storing the imaging data and a composition store for storing imaging compositions having links to the imaging data serviced as a single unit.

The current available printing systems implemented with a web interface generally use specialized printer drivers and port monitors to capture the imaging information for uploading to the server providing the printing. However, under these current systems, the imaging information is fundamentally associated with the server. As a result, the imaging information is limited for use only with the server that downloaded the imaging data.

One of the most recognized printing systems implemented with a web interface currently known today is the web site “Mimeo.com” provided by Mimeo.com, Inc. The Mimeo.com is an online copy center where users can print a document straight from their desktop application to the Mimeo.com printers. Specific software from Mimeo.com must first be downloaded and installed onto the user computers. Once the software is installed, users can choose a Mimeo.com printer from the print menu when printing from their desktop application. Users can then choose the Mimeo.com printer just as if it were a typical printer. Another menu will then pop up on users' screens that enables the user to select the current document and transfer it to the Mimeo.com web site. At the site, the document is transferred to a storage place assigned to the user by the Mimeo.com server, and a web content with a preview of the document and printing options will be displayed to the user. The document remains in the storage place for user selection for a limited time.

One problem with the Mimeo.com system is that the downloaded document can be used only on the Mimeo.com web site and users are not allowed to send the downloaded document to another online service. Another problem is that the user must choose a specific printer, and the document is downloaded based on the chosen specific printer. For example, if the user chooses a black and white printer, the downloaded document can be used only with the black and white printers. If the user wishes to print the same document to a color printer, the document has to be printed and downloaded again with the color printer chosen. This can be burdensome, inflexible and wasteful of bandwidth.

Another known printing system from HDE.com provided by HDE Inc., which provides an Internet Printing solution that allows printing through a firewall system over the Internet. Again, special software must be installed on the end-user's computer transmitting the print jobs to a destination printer over the Internet. In addition, the destination printer also contains special firmware to receive these transmitted print jobs.

Still the problem with the HDE's Internet printing solution is that both the user's computer and the printing device have to be preconfigured and installed with specific software before users can utilize the printing service. The problem with the need for preconfiguration is very burdensome and inflexible. Furthermore, it is extremely inconvenient for users of any computing devices that are more mobile and may require connection to different network environments offered by various location sites.

### BRIEF SUMMARY OF THE INVENTION

The present invention is directed to an improved system and method for preparing imaging data for printing to a requested web service from an application loaded on a user's computing device. More particularly, the present invention relates to a system and method for preparing imaging data for printing from an application from a computer or computing device with a web browser and a capture driver having a printer driver and a port monitor to a requested web service provided by a web service server, wherein the computer is linked to a personal imaging repository having an imaging data store for storing the imaging data and a composition store for storing imaging compositions having links to the imaging data serviced as a single unit.

The present invention provides a system that includes an imaging client computer having a web browser for printing from the application, which may be a desktop application, to the requested web service, a personal imaging repository associated with a particular user for storing imaging data that is to be accessed by the requested web service, and a capture driver for preparing the imaging data for transfer to the personal imaging repository. The personal imaging repository acts as an exchange infrastructure between the imaging data and the available web services on the Internet.

The present invention further provides a method that includes the steps of transferring the imaging data to the imaging data store, creating an imaging composition having links to the imaging data stored in the imaging data store, saving the imaging composition in the composition store and directing the web browser to the requested web service.

### DESCRIPTION OF THE DRAWINGS

FIG. 1 is a preferred architectural diagram of a network system in which the present invention can be implemented;

FIG. 2 is an architectural diagram of a second network system in which the present invention can be implemented; and,

FIG. 3 is a flowchart illustrating the preferred functionality of the print method of the present invention.

### GLOSSARY OF TERMS AND ACRONYMS

The following terms and acronyms are used throughout the detailed description:

Client-Server. A model of interaction in a distributed system in which a program at one site sends a request to a program at another site and waits for a response. The requesting program is called the “client,” and the program which responds to the request is called the “server.” In the context of the World Wide Web (discussed below), the client is a “Web browser” (or simply “browser”) which runs on the computer of a user; the program which responds to browser requests by serving Web pages, or other types of Web content, is commonly referred to as a “Web server.”

Composition store. Composition store refers to a network service or a storage device for storing imaging composition(s) that can be accessed by the user or other web services.

Content. A set of executable instructions that is served by a server to a client and that is intended to be executed by the client so as to provide the client with certain functionality. Web content refers to content that is meant to be executed by operation of a Web browser. Web content, therefore, may non-exhaustively include one or more of the following: HTML code, SGML code, XML code, XSL code, CSS code, Java applet, JavaScript and C-“Sharp” code.

Exchange infrastructure. An exchange infrastructure is a collection of services distributed throughout a network that stores imaging data associated with a particular user through a user profile.

Hyperlink. A navigational link from one document to another, from one portion (or component) of a document to another, or to a Web resource, such as a Java applet. Typically, a hyperlink is displayed as a highlighted word or phrase that can be selected by clicking on it using a mouse to jump to the associated document or document portion or to retrieve a particular resource.

Hypertext System. A computer-based informational system in which documents (and possibly other types of data entities) are linked together via hyperlinks to form a user-navigable “web.”

Imaging composition. An imaging composition comprises links to imaging data serviced as a single unit.

Imaging data. Imaging data refers to digital data capable of being represented as two dimensional graphics, such as a Portable Document Format (“PDF”) file or a Joint Photographic Experts Group (“JPEG”) file.

Imaging data store. Imaging data store refers to a network service or a storage device for storing imaging data that can be accessed by the user or other network services. The imaging data store preferably accepts the imaging data in multiple standard file formats, and the imaging data is converted into these file formats when necessary depending on the implementation.

Internet. A collection of interconnected or disconnected networks (public and/or private) that are linked together by a set of standard protocols (such as TCP/IP and HTTP) to form a global, distributed network. (While this term is intended to refer to what is now commonly known as the Internet, it is also intended to encompass variations which may be made in the future, including changes and additions to existing standard protocols.)

World Wide Web (“Web”). Used herein to refer generally to both (i) a distributed collection of interlinked, user-viewable hypertext documents (commonly referred to as Web documents or Web pages) that are accessible via the Internet, and (ii) the client and server software components which provide user access to such documents using standardized Internet protocols. Currently, the primary standard protocol for allowing applications to locate and acquire Web documents is HTTP, and the Web pages are encoded using HTML. However, the terms “Web” and “World Wide Web” are intended to encompass future markup languages and transport protocols which may be used in place of (or in addition to) HTML and HTTP.

Web Site. A computer system that serves informational content over a network using the standard protocols of the World Wide Web. Typically, a Web site corresponds to a particular Internet domain name, such as “HP.com,” and includes the content associated with a particular organization. As used herein, the term is generally intended to encompass both (i) the hardware/software server components that serve the informational content over the network, and (ii) the “back end” hardware/software components, including any non-standard or specialized components, that interact with the server components to perform services for Web site users. Importantly, a Web Site can have additional functionality, for example, a Web site may have the ability to print documents, scan documents, etc.

HTML (HyperText Markup Language). A standard coding convention and set of codes for attaching presentation and linking attributes to informational content within documents. (HTML 2.0 is currently the primary standard used for generating Web documents.) During a document authoring stage, the HTML codes (referred to as “tags”) are embedded within the informational content of the document. When the Web document (or HTML document) is subsequently transferred from a Web server to a browser, the codes are interpreted by the browser and used to display the document. Additionally in specifying how the Web browser is to display the document, HTML tags can be used to create links to other Web documents (commonly referred to as “hyperlinks”). For more information on HTML, see Ian S. Graham, The HTML Source Book, John Wiley and Sons, Inc., 1995 (ISBN 0471-11894-4).

HTTP (HyperText Transport Protocol). The standard World Wide Web client-server protocol used for the exchange of information (such as HTML documents, and client requests for such documents) between a browser and a Web server. HTTP includes a number of different types of messages which can be sent from the client to the server to request different types of server actions. For example, a “GET” message, which has the format GET <URL>, causes the server to return the document or file located at the specified URL.

URL (Uniform Resource Locator). A unique address which fully specifies the location of a file or other resource on the Internet or a network. The general format of a URL is protocol: //machine address:portipath/filename.

User Information. User information is identification and security information used in accessing imaging composition(s) and imaging data associated with a particular user profile. It is preferably accessed either directly or indirectly through methods provided by an extension component integrated into the web browser.

PDA (Personal Digital Assistant). A small hand-held computer used to write notes, track appointments, email and web browser with generally with far less storage capacity than a desktop computer.

Personal imaging repository. A personal imaging repository is a conceptual term describing the exchange infrastructure used to exchange imaging composition and imaging data with web services. Users are associated with their imaging data through user profiles.

### DETAILED DESCRIPTION

Broadly stated, the present invention is directed to an improved system and method for preparing imaging data for printing to a requested web service from an application loaded on a user's computing device. The system and method prepare imaging data to be serviced and direct it to a requested web service pursuant to a user request from an application. The imaging data is first stored in a personal imaging repository, which acts as an exchange infrastructure between the imaging data and available web services on the Internet. As a result, the imaging data stored in the personal imaging repository can freely be used by other web services or the user at a later time. Furthermore, it is no longer necessary for the imaging data to be downloaded to the requested web service. Rather, once the imaging data is stored in the personal imaging repository, it can be used later by any other web services.

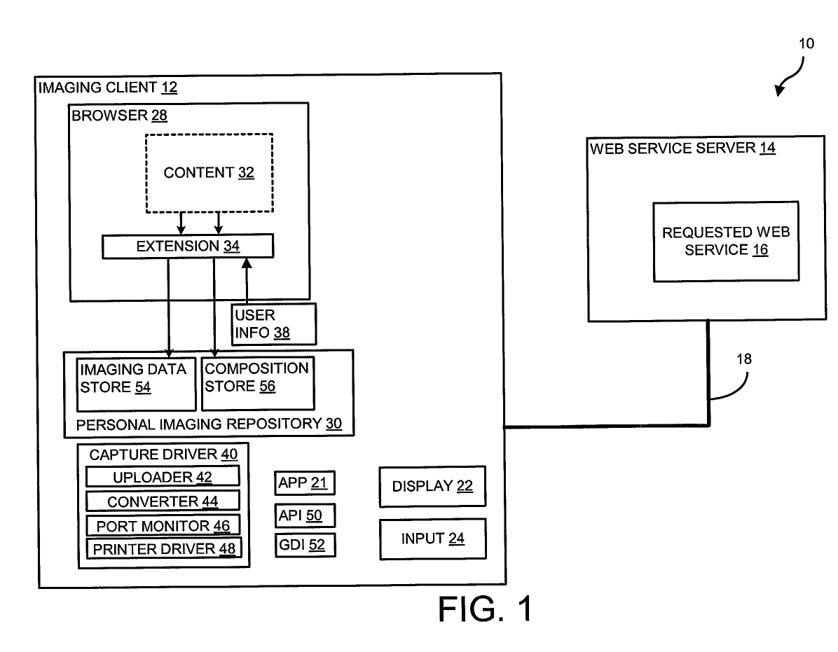

The preferred network system in which the present invention can be implemented is shown in FIG. 1 and indicated generally at 10. Because there are numerous ways of implementing the network topology of the present invention, the current preferred network system is just one way. As a result, it should be understood that other network topologies are contemplated and are within the scope of the present invention. In the preferred embodiment, an imaging client computer 12 is connected to a web service server computer 14 that provides a requested web service 16 via a network 18. The imaging client computer 12 establishes a connection with the web service server computer 14 upon the user selecting PRINT from an application 21 installed on the imaging client to the requested web service 16. It should be emphasized that the implemented network would most likely have multiple web services that are available over the Internet, and FIG. 1 shows only the requested web service.

The imaging client computer 12 also includes the typical components of a general computer, such as a display interface 22 and an input interface 24. In addition, the imaging client computer 12 preferably includes a web browser 28 and a personal imaging repository 30. Once the requested web service 16 is connected with the imaging client computer 12, the web service returns a web content 32 to the web browser 28. The web browser also includes an extension component 34, which makes use of user information 36 to provide web content with access to personal imaging repository 30 belonging to a particular user.

In addition, the imaging client also includes a capture driver 40, which is an important aspect of the present invention. The capture driver 40 prepares the imaging data from the application requesting printing to the requested web service 16. The capture driver 40 is further configured as one of the print options of the operating system as if it were a typical printer. Users can select to print to the capture driver 40 from any of their applications just like any typical printers. However, unlike a typical printer, users, using the capture driver, can print to a requested web service. In the preferred embodiment, the capture driver 40 has four separate components, namely, an uploader 42, a converter 44, a port monitor 46 and a printer driver 48. More specifically, the port monitor 46 is responsible for directing the imaging data to the personal imaging repository 30, and the uploader 42, as its name indicates, uploads the imaging data to the personal imaging repository as directed by the port monitor. The converter 44 and printer driver 48 are both converters. The printer driver 48 converts the imaging data requested for printing into a predefined format suitable for printing to a peripheral device, which is preferably in the postscript format because it works with most commercially available printers. The converter 44, on the other hand, converts the imaging data into the default format of the personal imaging repository 30.

The components of the capture driver 40 are configured to work with the operating system of the imaging client 12 through an Application Program Interface (“API”) 50 and a Graphic Display Interface (“GDI”) 52, which is well known in the art. The API 50 provides an interface that allows an application program to access the operating system and other services, and the GDI 52 provides an interface that allows graphics to be displayed in Microsoft Windows. Different interfaces may be used with the present invention, which depends greatly upon the configuration of the operating system installed on the imaging client. Although an implementation with MS Windows is shown in FIG. 1, implementations with other operating systems are contemplated and are within the scope of the present invention.

It should also be noted that the capture driver 40 can be implemented in a variety of ways. In fact, some of the components can be excluded. It is not necessary that the imaging data be converted into the predefined format. The printer driver 48 is implemented to generate device independent data. Similarly, since the converter 44 converts the imaging data into the default format of the personal imaging repository, the converter 44 does not necessarily have to be included. For example, the predefined format can be the same as the default format. Alternatively, the burden of converting the imaging data can be placed on the web service accessing the data. Consequently, there are numerous ways to implement the capture driver 40, and these other implementations are within the scope of the present invention.

The personal imaging repository 30, on the other hand, preferably includes an imaging data store 54, i.e., a digital memory, for storing the imaging data and a composition store 56 for storing imaging composition(s) of the imaging data that are serviced as a single unit. An imaging composition preferably comprises links to the imaging data, which can be located on another network service. As a result, the composition store 56 stores only the imaging compositions. The imaging data store 54, on the other hand, is any imaging data store located on any computer that contains the imaging data. More specifically, each web service can have its own imaging data store 54 available to the public.

For example, at some previous time, a user may have printed an article from a web service site, resulting in an imaging composition being created and stored in the user's composition store 56. Since the created imaging composition contains only the link to the imaging data for this article stored on the web service site, the imaging data for the article is not in the imaging data store 54 located on the imaging client 12. Rather, the imaging data is stored in the imaging data store located on the web service site, which is not shown in FIG. 1. Of course, users will have an imaging data store 54 that belongs to their user identification where they can store imaging data, which is the imaging data store shown in the imaging client 12. As a result, the term “personal imaging repository” 30 is meant as a conceptual term for an exchange infrastructure between the imaging data and the available web services on the Internet. Similar to the term “web,” which denotes millions of distinct servers that comprise the web, the web does not actually do anything itself. In the present invention, the servers serving the imaging data store 54 and the composition store 56 are physical implementations of the personal imaging repository 30 as a concept.

Because the web services are configured to access the personal imaging repository when a service is requested, the personal imaging repository 30 becomes the exchange infrastructure for the imaging data for the web services that are available on the Internet. Users no longer have to remember the directory in which they placed their imaging data. When the user requests a web service, the requested web service is configured to access the imaging data indicated by the selected imaging composition stored in the personal imaging repository. Furthermore, the imaging data is stored in the personal imaging repository, where it can be freely utilized by additional available web services.

It should be noted that the personal imaging repository 30 can represent any type of data storage device. In fact, the data storage device 30 does not necessarily have to be located within the imaging client computer 12. The personal imaging repository 30 can be located, for example, on another storage medium, which the client machine can access through alternative communication links. Although it is currently preferred to include the personal imaging repository 30 with the imaging client 12, this would likely change as bandwidth becomes faster and the popularity and storage capacity of the personal digital assistant (“PDA”) increases. These alternative implementations are contemplated and should be considered to be within the scope of the present invention.

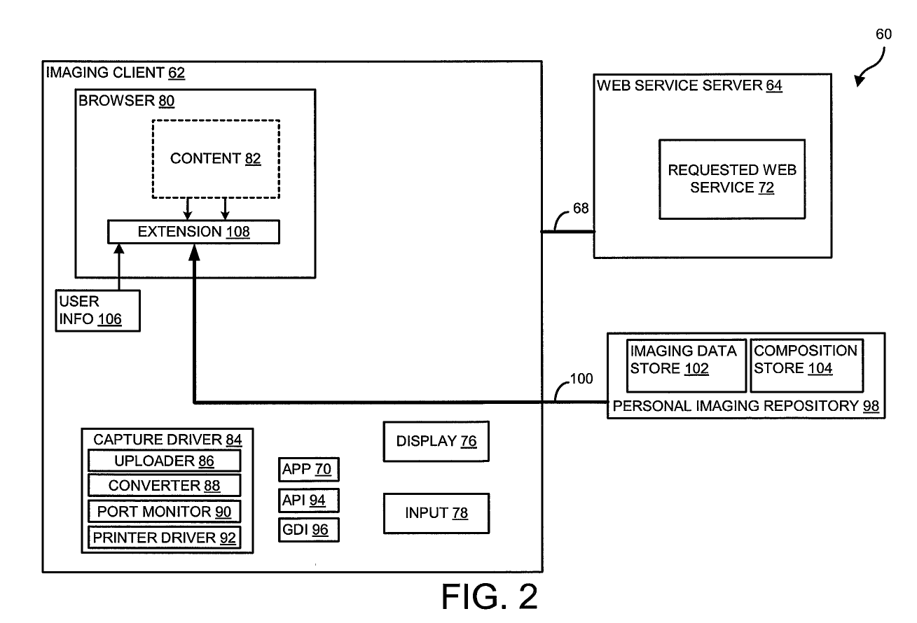

A second network system is shown in FIG. 2, and indicated generally at 60. Similar to the previous embodiment, an imaging client 62 is connected to a web service server 64 through a network connection 68. A connection with the web service server 64 is established by the imaging client when the user requests printing of imaging data from an application 70 to a requested web service 72 provided by the web service server. In the actual implementation, there would be multiple web services available. However, the imaging client 62 will only establish a connection with the web service that is requested by the user. The imaging client 62 similarly includes a display interface 76, an input interface 78 and a web browser 80 for displaying a web content 82 from the requested web service 72. In addition, a capture driver 84 along with its components, namely, an uploader 86, a converter 88, a port monitor 90 and a printer driver 92, are all located on the imaging client 62. In order for the capture driver 84 to work with the operating system, an API 94 and a GDI 96 are also included in the system.

However, unlike the previous implementation, the personal imaging repository 98 is linked only to the imaging client 62 over a general communication link 100. In the present implementation, the personal imaging repository 98 can be a general data storage device, or it may be provided by another server computer connected to the imaging client. In fact, the imaging client 62 can be a PDA that links to the personal imaging repository 98 by using a cradle. The personal imaging repository 98 similarly includes an imaging data store 102 and a composition store 104. The personal imaging repository is still associated with user information 106 used by an extension component 108 of the browser 80.

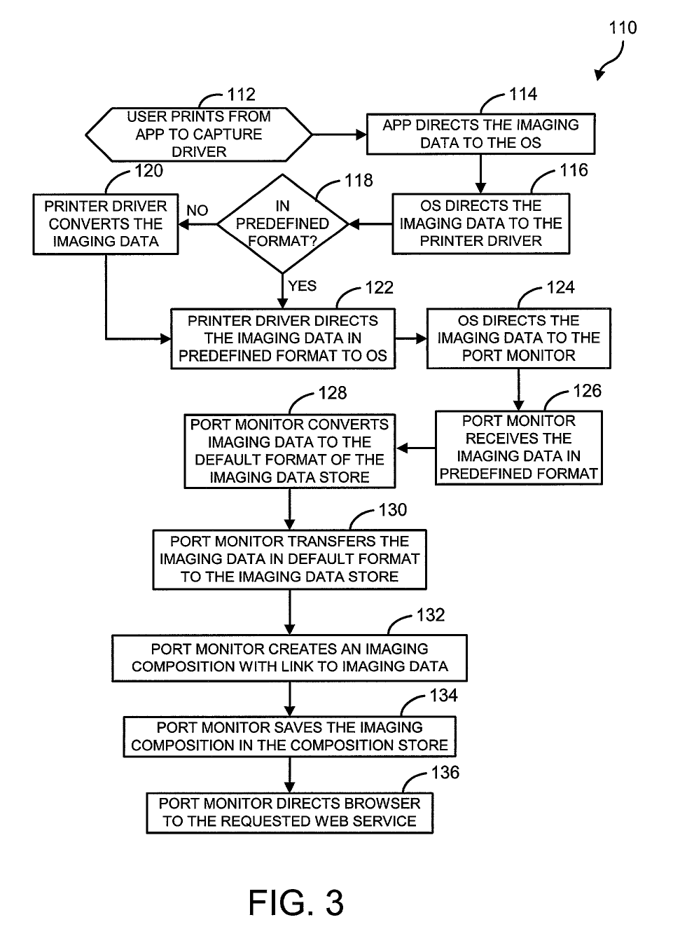

Turning to an important aspect of the present invention, a flow chart of the preferred functionality of the print method is shown in FIG. 3, and indicated generally at 110. The print method is initiated by the user selecting to print imaging data from an application to the capture driver 40, 84 (block 112). The application responds by directing the imaging data to the operating system (block 114). In turn, the operating system directs the imaging data to a printer driver (block 116). It is then determined whether the imaging data is in a predefined format that is suitable for printing to peripheral devices (block 118). The printer driver converts the imaging data into the predefined format if necessary (block 120), and directs the imaging data in the predefined format back to the operating system (block 122). The operating system then redirects the imaging data to a port monitor (block 124).

After the port monitor receives the imaging data that is in the predefined format (block 126), the port monitor converts the imaging data into a default format of the personal imaging repository (block 128). After the imaging data is converted into the default format, it is now ready to be transferred to the imaging data store (block 130). At this point, the port monitor creates an imaging composition that includes the link to the imaging data previously stored in the imaging data store (block 132), and the imaging composition is then saved into the composition store (block 134). As the last step, the port monitor directs the web browser of the imaging client to the requested web service for printing the imaging data (block 136).

From the foregoing description, it should be understood that an improved system and method for preparing imaging data for printing to a requested web service has been shown and described, which has many desirable attributes and advantages. The system and method provides for preparing imaging data for printing from an application to a requested web service that allows the imaging data to be later used by other web services. The imaging data is stored onto a personal imaging repository, which acts as an exchange infrastructure between the imaging data and available web services. Because the web services are configured to access the personal imaging repository for the imaging data, it is no longer necessary for the imaging data to be uploaded to the requested web service. Rather, once the imaging data is stored in the personal imaging repository, it can be used by any other web services or the user at a later time.

While various embodiments of the present invention have been shown and described, it should be understood that other modifications, substitutions and alternatives are apparent to one of ordinary skill in the art. Such modifications, substitutions and alternatives can be made without departing from the spirit and scope of the invention, which should be determined from the appended claims.

Various features of the invention are set forth in the appended claims.

What is claimed is:

1. A system for preparing imaging data for printing to a requested web service from an application loaded on a user's computing device, comprising:
an imaging client computer having a web browser for printing from the application to the requested web service;
a personal imaging repository associated with a particular user for storing imaging data that is to be accessed by the requested web service; and,
a capture driver for preparing the imaging data for transfer to said personal imaging repository;
wherein said personal imaging repository is an exchange infrastructure between the imaging data and available web services on the Internet.

2. The system as defined in claim 1 wherein said imaging client computer further comprising user information for associating the user with said personal imaging repository.

3. The system as defined in claim 2 wherein said user information is accessed through an extension component of said web browser.

4. The system as defined in claim 1 wherein said personal imaging repository stores the imaging data in a plurality of file formats.

5. The system as defined in claim 1 wherein said personal imaging repository comprises an imaging data store for storing imaging data.

6. The system as defined in claim 5 wherein said imaging data store is assigned to the user associated with said personal imaging repository for storing imaging data for user usage.

7. The system as defined in claim 5 wherein said imaging data store is assigned to a web service for storing imaging data available to the public.

8. The system as defined in claim 1 wherein said personal imaging repository comprises a composition store for storing imaging compositions of imaging data serviced as a single unit.

9. The system as defined in claim 8 wherein said imaging composition further comprising a link reference for each imaging data.

10. The system as defined in claim 1 wherein said capture driver further comprising:
a printer driver for converting the imaging data in a predefined format suitable for printing to a peripheral device;
a port monitor for directing the imaging data to said personal imaging repository;
an uploader mechanism for storing the imaging data onto said personal imaging repository; and,
a conversion mechanism for converting the imaging data into a default format of the personal imaging repository.

11. The system as defined in claim 10 wherein said predefined format suitable for printing is page description language.

12. The system as defined in claim 11 wherein said predefined format suitable for printing is any one from the group consisting of:
Postscript Format;
Printer Control Language; and,
Hewlett Packard Graphics Language.

13. The system as defined in claim 10 wherein said default format of said personal imaging repository is any one from the group consisting of:
Joint Photographic Experts Group Format;
Graphics Interchange Format;
Portable Network Graphics Format;
Tagged Image File Format;
Portable Document Format; and,
Microsoft Windows bitmap format.

14. A computer for preparing imaging data for printing from an application to a requested web service, comprising:
a web browser for printing to the requested web service;
a personal imaging repository associated with a particular user for storing imaging data that is to be accessed by the requested web service; and,
a capture driver for preparing the imaging data for transfer to said personal imaging repository;
wherein said personal imaging repository is an exchange infrastructure between the imaging data and available web services on the Internet.

15. A capture driver for preparing the imaging data for printing from an application located on a client computer with a web browser to a requested web service, comprising:
a port monitor for directing the imaging data to said personal imaging repository; and,
an uploader mechanism for storing the imaging data into said personal imaging repository;
wherein said port monitor forwards the web browser to the requested web service.

16. The capture driver as defined in claim 15 further comprising:
a printer driver for converting the imaging data into a predefined format suitable for printing to a peripheral device; and,
a conversion mechanism for converting the imaging data into the default format of the personal imaging repository.

17. A method for preparing imaging data for printing from an application located on a computer with a web browser and a capture driver having a printer driver and a port monitor to a requested web service provided by a web service server, wherein the computer is linked to a personal imaging repository having an imaging data store for storing the imaging data and a composition store for storing imaging compositions having links to the imaging data serviced as a single unit, said method comprising the steps of:
transferring the imaging data to the imaging data store;
creating an imaging composition having links to the imaging data stored in the imaging data store;
saving the imaging composition in the composition store; and,
directing the web browser to the requested web service.

18. The method according to claim 17 wherein prior to said step of transferring the imaging data further comprising the steps of:
directing the imaging data to the operating system by the application; and,
directing the imaging data to the printer driver by the operating system.

19. The method according to claim 17 wherein prior to said step transferring the imaging data further comprising the steps of:
determining whether the imaging data is in a predefined format suitable for printing to a peripheral device;
converting the imaging data to the predefined format when the imaging data is not in the predefined format; and,
directing the imaging data in the predefined format to the operating system.

20. The method according to claim 19 wherein said step of directing the imaging data further comprising the steps of:
directing the imaging data in the predefined format to the port monitor;
receiving the imaging data in the predefined format by the port monitor;
converting the imaging data in the predefined format to a default format of the imaging data store.

21. The method according to claim 17 wherein prior said step of transferring the imaging data further comprising the step of converting the imaging data into a default format of the imaging data store.

22. A computer program product comprising a computer usable medium having computer readable program codes embodied in the medium that when executed cause a computer to:
transfer the imaging data to an imaging data store;
create an imaging composition having links to the imaging data stored in the imaging data store;
save the imaging composition in a composition store; and,
direct a web browser located on the computer to a requested web service.

23. A computer program product comprising a computer usable medium having computer readable program codes embodied in the medium that when installed in a computer having a web browser linked to a personal imaging repository with an imaging data store for storing the imaging data and a composition store for storing imaging compositions having links to the imaging data serviced as a single unit, the product causes the computer to:
transfer the imaging data to an imaging data store;
create an imaging composition having links to the imaging data stored in the imaging data store;
save the imaging composition in a composition store; and,
direct the web browser to a requested web service.

24. A driver comprising a computer usable medium having computer readable program codes embodied in the medium that when installed in a computer having a web browser linked to a personal imaging repository with an imaging data store for storing the imaging data and a composition store for storing imaging compositions having links to the imaging data serviced as a single unit, the driver causes the operating system to:
transfer the imaging data to an imaging data store;
create an imaging composition having links to the imaging data stored in the imaging data store;
save the imaging composition in a composition store; and,
direct the web browser to a requested web service.
